(19) United States
(12) Patent Application Publication
(10) Pub. No.: US 2026/0134795 A1
(43) Pub. Date: May 14, 2026

(54) METHOD AND SYSTEM FOR PROVIDING USER-TAILORED FOREIGN LANGUAGE LEARNING SERVICE BASED ON AI TUTOR CAPABLE OF REAL-TIME INTERACTION

(71) Applicant: Tutorus Labs Inc., Seoul (KR)

(72) Inventors: Minyoung KYOUNG, Daejeon (KR); Hyungbae JEON, Daejeon (KR); Joon Ho LIM, Daejeon (KR); Jeon Gue PARK, Seoul (KR)

(73) Assignee: Tutorus Labs Inc., Seoul (KR)

(21) Appl. No.: 19/265,260

(22) Filed: Jul. 10, 2025

(30) Foreign Application Priority Data
Nov. 11, 2024 (KR) 10-2024-0159111

(51) Int. Cl. G09B 19/06; G09B 7/06; G10L 15/26

(52) U.S. Cl. CPC G09B 19/06; G09B 7/06; G10L 15/26

(57) ABSTRACT

The present disclosure relates to a method and system for providing a user-tailored foreign language learning service based on an AI tutor capable of real-time interaction, and more particularly, to a method and system for providing a user-tailored foreign language learning service based on an AI tutor which not only is capable of real-time interaction but also capable of providing an immediate learning feedback to enable a user to conduct foreign language learning while conversing with the AI tutor in a chat format.

### CROSS REFERENCE TO RELATED APPLICATION

This application claims the priority of Korean Patent Application No. 10-2024-0159111, filed with the Korean Intellectual Property Office on Nov. 11, 2024, which is incorporated herein by reference in its entirety.

### STATEMENT REGARDING GOVERNMENT SPONSORED RESEARCH

This work was supported by Institute of Information & communications Technology Planning & Evaluation (IITP) grant funded by the Korea government (MSIT) (RS-2023-00262158, Development of AI Analytics-Generation-Coaching Copilot Technology for Augmented Teachers' Competency-Customized Education).

### BACKGROUND OF THE INVENTION

### Field of the Invention

The present disclosure relates to a method and system for providing a user-tailored foreign language learning service based on an AI tutor capable of real-time interaction, and more particularly, to a method and system for providing a user-tailored foreign language learning service based on an AI tutor which not only is capable of real-time interaction but also capable of providing an immediate learning feedback to enable a user to conduct foreign language learning while conversing with the AI tutor in a chat format.

### Description of the Related Art

A conventional user-tailored learning service providing system includes Korean Patent Application No. 10-2016-0102310 entitled “User Centered Foreign Language Education Method and Server Performing the Same.” The system includes a step of receiving user voice data generated by recording user speech from a terminal device while a specific group of foreign language learning video data among groups of foreign language learning video data is outputted through the terminal device, a step of comparing a user voice obtained by analyzing the user voice data with a control group voice of the outputted foreign language learning video data to calculate a voice imitation probability, and a step of repeatedly providing the foreign language learning video data depending on whether the voice imitation probability is equal to or greater than a reference probability.

In addition, in Korean Patent Application No. 10-2017-0066868 entitled “Personal Customized Sentence Automatic Recommendation Foreign Language Learning System,” vocabulary for use in 1:1 or multi-party conversations is presented to a person in a customized manner in an easy-to-use application format, and user-centered optimized learning is supported by presenting sentence corrections and topics as issues according to individual levels, language habits and interests.

However, conventional AI-based user-tailored learning service providing systems including these systems have limitations in that they focus only on user-tailored learning that merely analyzes the correlation between information on a user and content to determine which content to provide or that merely performs simple branching processing based on whether a user answered a given question correctly.

Due to this, a problem arises in that a limited learning experience is provided because it is difficult for a user to directly obtain information he or she wants.

Especially, in the case of foreign language learning, it is essential to judge whether a learner accurately understands and utilizes the meanings of vocabulary or expressions and at the same time provide an immediate feedback on a learner's difficult or incorrect answer. However, conventional learning service technologies only provide information on whether an answer is correct or not, and have limitations in that they do not allow a learner to ask a question or do not provide necessary information in real time.

Accordingly, in the relevant technical field, there is a demand for technological development to provide a new learning method and system that may determine whether a learner accurately understands and utilizes the meanings of vocabulary or expressions and at the same time may provide an immediate feedback on a learner's difficult or incorrect answer.

### SUMMARY OF THE INVENTION

The present disclosure is to solve the above problems, and provides a method and system for providing a user-tailored foreign language learning service based on an AI tutor capable of real-time interaction, including a function of outputting foreign language learning content (conversation data including a situation, a role, vocabulary and expressions to be used, etc.) to a learner in the form of a chat using an AI tutor chatbot, a function of causing an AI tutor to guide a learning process or interact with a user in real time, a function of providing a learning feedback by analyzing the learner's answer from various angles, and a function of providing personalized learning content tailored to the learner, thereby providing an efficient foreign language learning method by building a system capable of determining whether the learner accurately understands and utilizes the meanings of vocabulary or expressions and providing an immediate feedback on an answer that the learner finds difficult or incorrect.

In addition, the present disclosure provides a method and system for providing a user-tailored foreign language learning service based on an AI tutor capable of real-time interaction that provides a user-tailored foreign language learning service based on an AI tutor capable of real-time interaction to provide an immediate feedback on a learner's answer and naturally guide learning through chat-type conversation, thereby enhancing the learner's understanding.

In addition, the present disclosure provides a method and system for providing a user-tailored foreign language learning service based on an AI tutor capable of real-time interaction that provides personalized learning content to realize customized education tailored to the learning level of each user, thereby providing an efficient foreign language learning experience.

However, objects of the present disclosure are not limited to those set forth above, and other unmentioned objects would be apparent to one of ordinary skill in the art from the following description.

In order to achieve the above objects, a system for providing a user-tailored foreign language learning service based on an AI tutor capable of real-time interaction according to an embodiment of the present disclosure includes: a chat module (321) configured to manage chat messages exchanged with a user who operates each user terminal (100); and an AI tutoring module (322) configured to generate a conversation message based on given content and a conversation record (including a current user answer) between the chat module (321) set as an AI tutor role in content and the user, perform a check on an answer provided by the user terminal (100), and provide an immediate feedback based on the check to fit the given content and the context of a conversation.

The chat module (321) includes a voice recognition means (321a) configured to receive text or voice inputted from the user and convert voice into text when voice is inputted, and manages a conversation record between the AI tutor and the user through interaction in text with the AI tutoring module (322).

In addition, the AI tutoring module (322) includes: a content conversation model (322a) and a general conversation model (322c) configured to generate conversation messages by branching into cases where a user answer is within an answer matching degree and is out of the answer matching degree, according to answer matching degree analysis of the user answer in the given content and the conversation record; and an answer discrimination model (322b) configured to determine whether a user answer is within the answer matching degree or out of the answer matching degree.

In addition, the AI tutoring module (322) further includes a feedback model (322d) configured to, when there is a grammatical error in an answer inputted by the user or when an answer is not provided in a sentence form, correct the error or provide a complete sentence as a feedback to the user terminal (100), and recommend a multiple-choice hint answer so that a learner is able to successfully perform a given mission.

In addition, the system further includes a learning analysis module (323) configured to analyze the user's learning level based on a conversation record between the user and the AI tutor to recommend content suitable the user, and provide adjusted content to the user.

In order to achieve the above objects, a method for providing a user-tailored foreign language learning service based on an AI tutor capable of real-time interaction according to an embodiment of the present disclosure includes: a first step in which a chat module (321) collects chat messages exchanged with a user who operates a user terminal (100) and provides a wake-up request to an AI tutoring module (322) for management; and a second step in which the AI tutoring module (322) generates a conversation message based on given content and a conversation record (including a current user answer) between the chat module (321) set as an AI tutor role in content and the user, performs a check on an answer provided by the user terminal (100) and provides an immediate feedback based on the check to fit the given content and the context of a conversation.

The first step further includes a step in which the chat module (321) receives text or voice inputted from the user and converts voice into text when voice is inputted, and manages a conversation record between the AI tutor and the user through interaction in text with the AI tutoring module (322).

In addition, the second step includes: a step in which the AI tutoring module (322) determines whether a user answer is within an answer matching degree or out of the answer matching degree, according to answer matching degree analysis of the user answer; and a step in which the AI tutoring module (322) generates conversation messages by branching into cases where the user answer is within the answer matching degree and is out of the answer matching degree, according to analysis of the appropriateness of the user answer in the given content and the conversation record.

In addition, the second step further includes a step in which the AI tutoring module (322), when there is a grammatical error in the answer inputted by the user or when the answer is not provided in a sentence form, corrects the error or provide a complete sentence as a feedback to the user terminal (100), and recommends a multiple-choice hint answer so that a learner is able to successfully perform a given mission.

In addition, the method further includes, after the second step, a third step in which a learning analysis module (323) analyzes the user's learning level based on a conversation record between the user and the AI tutor to recommend content suitable for the user and provides adjusted content to the user.

### BRIEF DESCRIPTION OF THE DRAWINGS

FIG. 1 is a diagram showing a system 1 for providing a user-tailored foreign language learning service based on an AI tutor capable of real-time interaction according to an embodiment of the present disclosure.

FIG. 2 includes diagrams showing (a) an AI tutor server 300 and (b) components of a chat module 321 of the AI tutor server 300 in the system 1 for providing a user-tailored foreign language learning service based on an AI tutor capable of real-time interaction according to the embodiment of the present disclosure.

FIG. 3 is a flowchart explaining the turn of chats provided by a chat means 321b in the system 1 for providing a user-tailored foreign language learning service based on an AI tutor capable of real-time interaction according to the embodiment of the present disclosure.

FIG. 4 is a diagram showing components of an AI tutoring module 322 of the AI tutor server 300 in the system 1 for providing a user-tailored foreign language learning service based on an AI tutor capable of real-time interaction according to the embodiment of the present disclosure.

FIG. 5 is a diagram showing components of a learning analysis module 323 of the AI tutor server 300 in the system 1 for providing a user-tailored foreign language learning service based on an AI tutor capable of real-time interaction according to the embodiment of the present disclosure.

FIG. 6A is a diagram showing a UI screen provided to a user terminal 100 on the system 1 for providing a user-tailored foreign language learning service based on an AI tutor capable of real-time interaction according to the embodiment of the present disclosure.

FIG. 6B shows the English translation of the diagram shown in FIG. 6A. The diagram of FIG. 6A includes two different languages, i.e., foreign language and native language, for example, English and Korean. FIG. 6B is presented to help understanding of all contents shown in FIG. 6A.

FIG. 7 is a flowchart showing a method for providing a user-tailored foreign language learning service based on an AI tutor capable of real-time interaction according to an embodiment of the present disclosure.

### DETAILED DESCRIPTION OF THE PREFERRED EMBODIMENTS

Hereinafter, a detailed description of a preferred embodiment of the present disclosure will be made with reference to the attached drawings. In describing the present disclosure below, if it is determined that a detailed description of a related known function or configuration may unnecessarily obscure the gist of the present disclosure, the detailed description will be omitted.

In the present specification, when any one component “transmits” data or a signal to another component, it means that the component may transmit the data or signal directly to the other component or may transmit the data or signal to the other component via at least one other component.

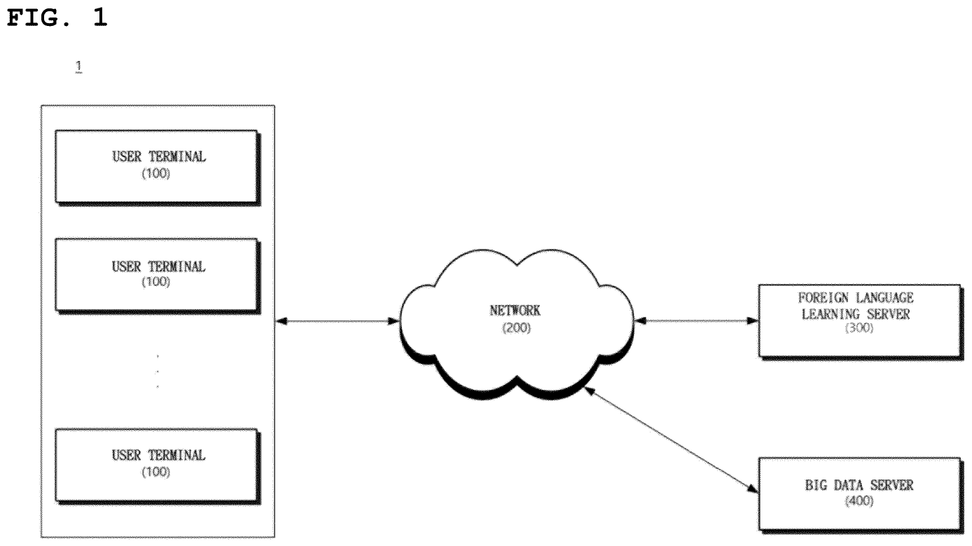

FIG. 1 is a diagram showing a system 1 for providing a user-tailored foreign language learning service based on an AI tutor capable of real-time interaction according to an embodiment of the present disclosure.

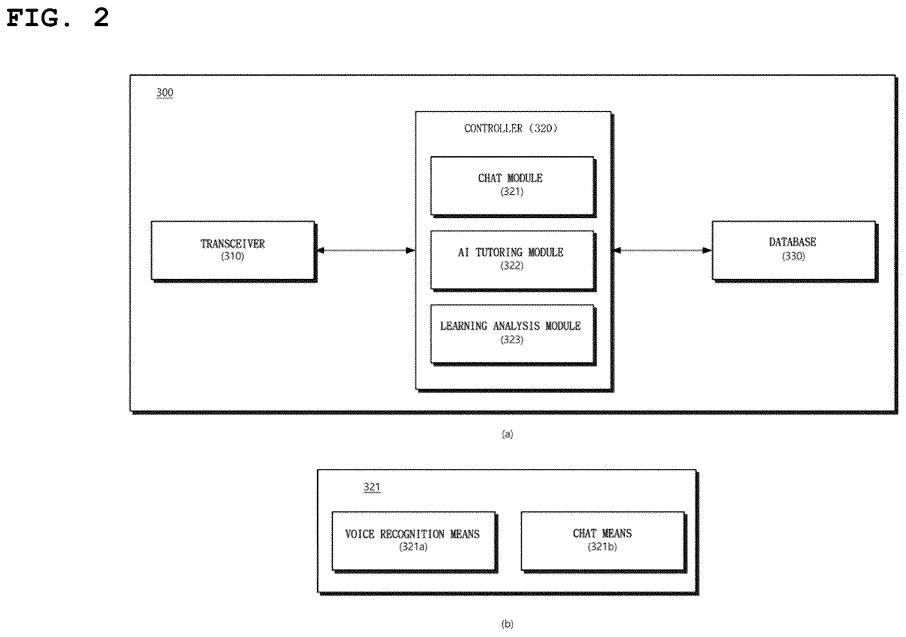

FIG. 2 includes diagrams showing (a) an AI tutor server 300 and (b) components of a chat module 321 of the AI tutor server 300 in the system 1 for providing a user-tailored foreign language learning service based on an AI tutor capable of real-time interaction according to the embodiment of the present disclosure.

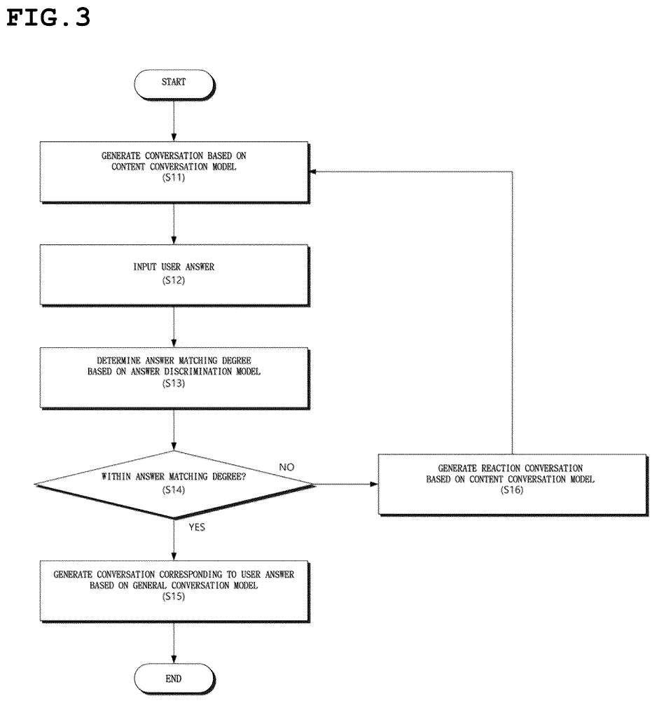

FIG. 3 is a flowchart explaining the turn of chats provided by a chat means 321b in the system 1 for providing a user-tailored foreign language learning service based on an AI tutor capable of real-time interaction according to the embodiment of the present disclosure.

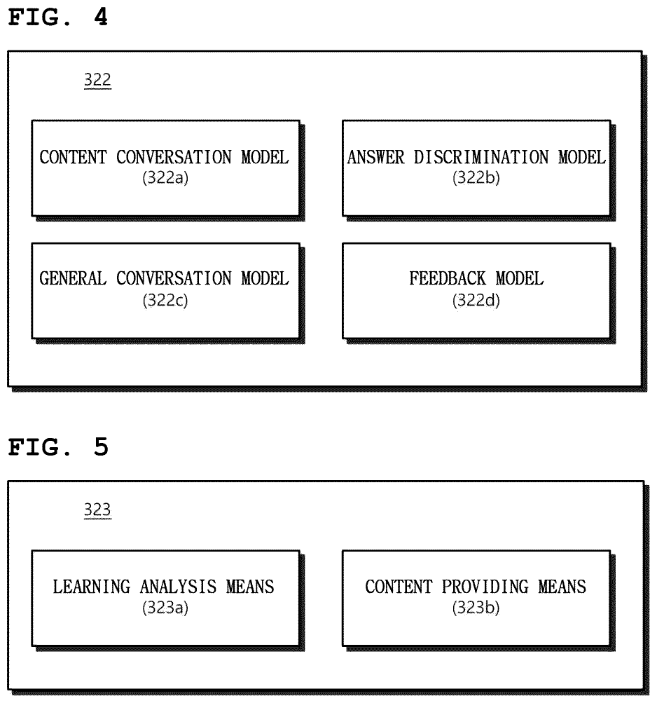

FIG. 4 is a diagram showing components of an AI tutoring module 322 of the AI tutor server 300 in the system 1 for providing a user-tailored foreign language learning service based on an AI tutor capable of real-time interaction according to the embodiment of the present disclosure.

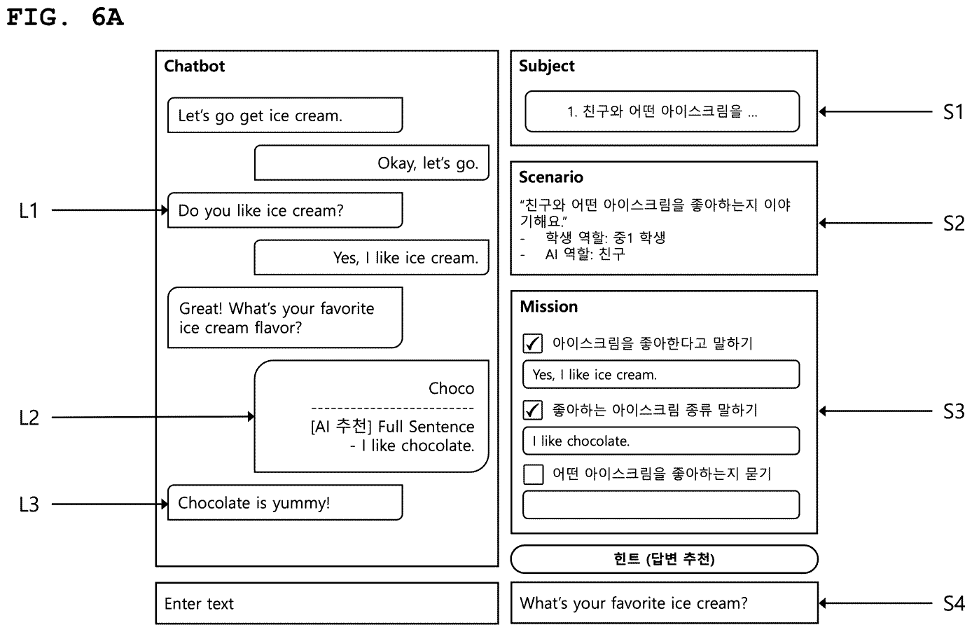

FIG. 5 is a diagram showing components of a learning analysis module 323 of the AI tutor server 300 in the system 1 for providing a user-tailored foreign language learning service based on an AI tutor capable of real-time interaction according to the embodiment of the present disclosure.

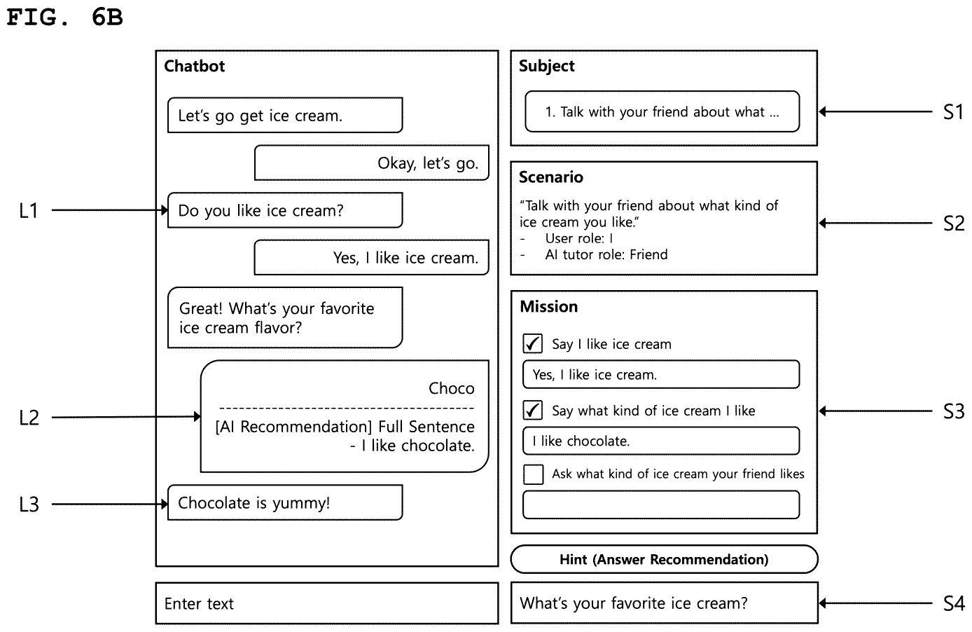

FIG. 6A is a diagram showing a user interface (hereinafter referred to as ‘UI’) screen provided to a user terminal 100 on the system 1 for providing a user-tailored foreign language learning service based on an AI tutor capable of real-time interaction according to the embodiment of the present disclosure. FIG. 6A shows the UI screen including Korean language, and FIG. 6B shows the corresponding English-translated version of the same screen. Although English and Korean are shown as exemplary foreign language and native language, the languages are not limited thereto. That is, the foreign language and the native language may be any two different languages.

First, referring to FIG. 1, a system 1 for providing a user-tailored foreign language learning service based on an AI tutor capable of real-time interaction may include a plurality of user terminals 100, a network 200, an AI tutor server 300, and a big data server 400.

The user terminal 100 may provide a user with the AI tutor chatbot UI screen of an AI tutor application, thereby providing content related with foreign language learning using a chat window displayed on the screen and allowing the user to directly type on a keyboard or input voice through a microphone to continue conversation.

That is to say, when the AI tutor application on the user terminal 100 receives text or voice inputted from the user and provides the text or voice to the AI tutor server 300 through the network 200, a voice recognition means 321a of a chat module 321 to be described below on the AI tutor server 300 may convert voice into text in the case of a voice input, and may manage the conversation record between the AI tutor and the user through interaction with an AI tutoring module 322 and a learning analysis module 323.

Meanwhile, for the sake of convenience in explanation, it is described in the present disclosure that the user terminal 100 and the AI tutor server 300 perform AI tutoring through the network 200. However, AI tutoring may also be performed through predetermined codes, matching the chat module 321, the AI tutoring module 322 and the learning analysis module 323, on the AI tutor application installed on the user terminal 100 and separate preset algorithms of a ‘chat area,’ an ‘AI tutoring area’ and a ‘learning analysis area’ that are logical units of hardware or software resources for performing the codes.

The network 200 is a communication network as a high-speed backbone network of a large-scale communication network capable of providing large-capacity, long-distance voice and data services, and may be a next-generation wired and wireless network for providing the Internet or high-speed multimedia services. When the network 200 is a mobile communication network, it may be a synchronous mobile communication network or an asynchronous mobile communication network. As an example of an asynchronous mobile communication network, a communication network using Wideband Code Division Multiple Access (WCDMA) technology may be cited. In this case, although not shown in the drawings, the mobile communication network 700 may include a Radio Network Controller (RNC). Although the WCDMA network is described as an example, the network 200 may also be a 3G LTE network, a 4G network, a next-generation communication network such as 5G, or other IP networks based on IP. The network 200 serves to mutually transmit signals and data between the plurality of user terminals 100, the AI tutor server 300, the big data server 400 and other systems.

The content provided to each user terminal 100 through the network 200 by the AI tutor server 300 according to an embodiment of the present disclosure may be as shown in Table 1 below.

TABLE 1

| Scenario | “Talk with your friend about what kind | |
|---|---|---|
| | of ice cream you like.” | |
| User role | I | |
| AI tutor role | Friend | |
| Mission | Answering a question | Using an expression |
| | Say I like ice cream | Use “Yes, I like ~” |
| | Say what kind of ice | Use “My favorite ~” |
| | cream I like | Use “What is ~” |
| | Ask what kind of ice | |
| | cream your friend likes | |
| Learning | Beginner level | |
| difficulty level | | |

As shown in Table 1 above, the content consists of data representing a curriculum, and is aimed for a user and an AI tutor to perform a given situation, role and mission in the form of chat. The mission may be set to include, but is not limited to, answering given questions or using specific expressions.

Learning difficulty level indicates the learning difficulty level of a given mission, and may be divided into beginner, intermediate and advanced levels, but is not limited thereto. The learning difficulty level may be adjusted according to a result in real time or over a preset period by the learning analysis module 323 to be described below.

Referring to FIG. 2(a), the AI tutor server 300 may include a transceiver 310, a controller 320 and a database 330, and the controller 320 may include the chat module 321, the AI tutoring module 322 and the learning analysis module 323. Referring to FIG. 2(b), the chat module 321 may include the voice recognition means 321a and a chat means 321b.

The main purpose of the voice recognition means 321a is to recognize a voice signal transmitted through the user terminal 100 and convert the voice signal into a text, and may be implemented using conventional deep learning-based voice recognition technology.

The main purpose of the chat means 321b is to manage chat messages exchanged between the user and the AI tutoring module 322, and depending on a function and a situation, may call each module of the AI tutoring module 322 and the learning analysis module 323 for a chat or store data for learning analysis. A chat method provided by the chat means 321b may be composed of a plurality of turns. The minimum number of chat turns may be determined by the number of missions, and the maximum number of chat turns may be set in advance by an administrator.

Each turn of the chat provided by the chat means 321b operates as shown in FIG. 3.

In other words, the chat means 321b performs conversation generation based on a content conversation model 322a of the AI tutoring module 322 (S11).

After the step S11, when the input of a user's answer is performed (S12), the chat means 321b performs a determination on whether the answer is within a preset answer matching degree, based on an answer discrimination model 322b of the AI tutoring module 322 (S13).

When the answer is within the preset answer matching degree as a result of the determination (YES of S14), the chat means 321b generates a reaction conversation based on the content conversation model 322a of the AI tutoring module 322 (S15).

On the other hand, when the answer is out of the preset answer matching degree as a result of the determination (NO of S14), the chat means 321b generates a conversation corresponding to the user answer based on a general conversation model 322c of the AI tutoring module 322 (S16), and returns to the step S11.

In another embodiment of the present disclosure, in order to analyze whether the user's answer is within the answer matching degree, the chat means 321b may access the big data server 400 through the network 200.

The content conversation model 322a and the general conversation model 322c may generate conversation messages within the answer matching degree based on given content (a scenario, a user role, an AI tutor role, a currently given mission, etc.) and a conversation record (including a current user answer).

To this end, the big data server 400 may analyze, through an answer matching degree algorithm, collected data stored in a distributed manner in a DCS DB, a distributed database that stores user answers for each chat by identification number of each given content by a distributed file program, and may extract a matching answer matching degree. In detail, an answer matching degree algorithm used in an analysis/control program may be one of a decision tree (DT) classification algorithm, a random forest classification algorithm and a support vector machine (SVM) classification algorithm.

The chat means 321b may analyze the collected data stored in a distributed manner in the DCS DB by the distributed file program. When performing the analysis, the chat means 321b may extract first to nth (n is a natural number equal to or greater than 2) parameters corresponding to a first parameter that is extracted because the first parameter corresponds to a word included in a word, phrase, expression or sentence corresponding to “an answer to an AI tutor's question,” due to correspondence to a scenario or mission set within a similar environment or similar situation range in content, a second parameter corresponding to a similarity by scenario and mission of the same or similar range for a similar environment or similar situation range in content matching each extracted first parameter, and so on.

Thereafter, the chat means 321b may multiply a first weight corresponding to the degree of sameness or similarity for the user's answer to a current AI tutor's question for the first parameter or the user's reaction to an AI tutor's answer, and may multiply a second weight according to the degree of similarity for the second parameter. In this way, the chat means 321b may multiply another parameter capable of reflecting the suitability of an additional answer or reaction and a weight that matches the parameter.

Then, the chat means 321b may sum quantitative values multiplied for the first to nth parameters and first to nth weights, may then calculate an answer matching degree according to the range of a summed value, and may control the transceiver 310 to extract at least one of a word, a phrase, an expression and a sentence with a relatively high answer matching degree to the user terminal 100 through the network 200.

In the same manner, the chat means 321b may analyze the collected data stored in a distributed manner in the DCS DB by the distributed file program. When performing the analysis, the chat means 321b may extract first to mth (m is a natural number the same as or different from n and equal to or greater than 2) parameters corresponding to a first parameter that is extracted because the first parameter corresponds to a word included in a word, phrase, expression or sentence corresponding to “an expression for the AI tutor's reaction,” due to correspondence to a scenario or mission set within a similar environment or similar situation range in content, a second parameter corresponding to a similarity by scenario and mission of the same or similar range for a similar environment or similar situation range in content matching each extracted first parameter, and so on.

Thereafter, the chat means 321b may multiply a first weight corresponding to the degree of sameness or similarity for the user's answer to a current AI tutor's question for the first parameter or the user's reaction to an AI tutor's answer, and may multiply a second weight according to the degree of similarity for the second parameter. In this way, the chat means 321b may multiply another parameter capable of reflecting the suitability of an additional answer or reaction and a weight that matches the parameter.

Then, the chat means 321b may sum quantitative values multiplied for the first to nth parameters and first to nth weights, may then calculate an expression matching degree according to the range of a summed value, and may control the transceiver 310 to extract at least one of a word, a phrase, an expression and a sentence with a relatively high expression matching degree to the user terminal 100 through the network 200. The expression matching degree may also be used in FIG. 3, etc. in the same manner as the answer matching degree described above.

Namely, depending on whether the user's answer is within the answer matching degree, the content conversation model 322a and the general conversation model 322c of the AI tutoring model 322 may generate a conversation in parallel. The determination on whether the user's answer is within the answer matching degree is performed based on the answer discrimination model 322b of the AI tutoring model 322.

For example, when the answer discrimination model 322b determines that the user's answer in a given conversation is within the answer matching degree, a reaction conversation may be generated through the content conversation model 322a, and a chat may proceed to the next turn. On the other hand, when the answer discrimination model 322b determines that the user's answer is inappropriate, the content conversation model 322a performs conversation generation for generating a conversation within the answer matching degree through the general conversation model 322c and guiding to a given curriculum.

Looking at the AI tutoring model 322 in more detail, as shown in FIG. 4, the AI tutoring model 322 is configured with the content conversation model 322a, the answer discrimination model 322b, the general conversation model 322c and a feedback model 322d, and may be used by being called in real time for chatting with a user by being linked with the chat module 321.

The content conversation model 322a and the general conversation model 322c may generate conversation messages within the answer matching degree based on given content (a scenario, a user role, an AI tutor role, a currently given mission, etc.) and a conversation record (including a current user answer).

The answer discrimination model 322b is used by being called in real time to determine whether the user's answer is within the answer matching degree for a currently given conversation and mission. The criteria for determining whether an answer is within the answer matching degree may be largely divided into AI-user answer relevance and mission-user answer relevance. The AI-user answer relevance checks whether the conversation between a given AI message (current conversation) and the user answer is natural, and mission-user answer relevance determines whether a given content mission, i.e., vocabulary or expressions, are used accurately. In the present embodiment, a user's answer is determined to be appropriate only when the user's answer passes both criteria, and criteria for determining the appropriateness of an answer, that is, an answer matching degree, may be diversified depending on a curriculum or a foreign language type, and are not limited to the above.

When there is a grammatical error in the answer inputted by the user or when the answer is not provided in a sentence form, the feedback model 322d may correct the error or provide a complete sentence as a feedback to the user terminal 100, and may recommend a multiple-choice hint answer so that the learner may successfully perform a given mission.

In more detail, the feedback model 322d may perform a first function related with a learning feedback, such as performing a grammar check on the user's answer, recommending a complete sentence that fits the given content and context of the conversation, etc.

In this case, when a grammatical error is found in the user's answer, the feedback model 322d shows an error type (e.g., typo, capitalization, punctuation, singular and plural, tense, etc.) and a corrected phrase, and highlights a part with the error and a corrected part to intuitively show the parts to the user.

When a user's answer is a short answer, the feedback model 322d may provide a second function of converting the answer into a complete sentence that fits the context of a conversation.

In addition, the feedback model 322d may provide, as a hint answer recommendation function, a third function of recommending an answer within an answer matching degree for a current mission based on a currently given conversation, but, when the user does not answer for several seconds or make a separate request, the model may generate and display a plurality of candidate sentences.

The all models 322a to 322d of the AI tutoring model 322 may be implemented by utilizing a “large language model (LLM)” that understands context and performs tasks such as generating sentences or answering questions, as an AI system capable of learning a large amount of text data and performing natural language processing tasks, and may be implemented to perform appropriate functions through prompt writing or model learning (Fine-Tuning, Parameter-Efficient Fine-Tuning, etc.).

That is to say, “Fine-Tuning”, which causes a pre-learned model to additionally learn for a specific dataset and generally updates the weights of the entire network to make a model suitable for a new task, and “Parameter-Efficient Fine-Tuning”, which is a method of adjusting only some parameters of a model instead of updating the entire parameters of the model or using additional parameters such as a method of learning only some layers or a method of fixing low-level parameters while adjusting only high-level parameters, may all perform tuning of a pre-learned model to suit the tasks of the respective models 322a to 322d.

As shown in FIG. 5, the learning analysis module 323 may be configured with a learning analysis means 323a and a content providing means 323b.

The learning analysis means 323a may perform the role of analyzing a user's learning level in order to recommend content suitable for the user.

A specific example of a method for analyzing a user's learning level by the learning analysis means 323a is to record errors in the use of words or grammar based on answers inputted by the user, thereby identifying the user's linguistic insufficiencies in foreign language conversation, and to record whether a mission is successfully completed, thereby identifying the user's weak points in a curriculum. In addition, the learning analysis means 323a may comprehensively consider these and record the user's current learning level by dividing it into beginner, intermediate and advanced levels.

The content providing means 323b may recommend and provide content suitable for the user based on a database that includes vocabulary, expressions, etc. that the learner should learn for each curriculum, including content such as Table 1, or the user may select the content.

The vocabulary and expressions provided in the content providing means 323b may be constructed by applying the criteria of a curriculum, but are not limited thereto. In order to recommend content suitable for the user, the content providing means 323b may provide content by matching the learning level of the user recorded in the learning analysis means 323a with the learning difficulty of the content, and may provide content for the recorded lack of foreign language conversation.

FIG. 6A shows a UI screen provided to the user terminal 100. FIG. 6A illustrates the UI screen including Korean language, and FIG. 6B illustrates the English-translated version of the same screen shown in FIG. 6A to help understanding of the contents shown in FIG. 6A. In the screen of the user terminal 100, L1 represents a curriculum inducement conversation by an AI tutor in a specific mission of the content, L2 represents a recommendation of a complete sentence (including grammar check), and L3 represents the generation of an appropriate response message to the user's answer.

In addition, S1 described above represents selected curriculum content, S2 represents AI role assignment for each content, S3 represents judgment of the appropriateness of a user answer (conversation flow, slang, etc.), and S4 represents an appropriate answer recommendation service.

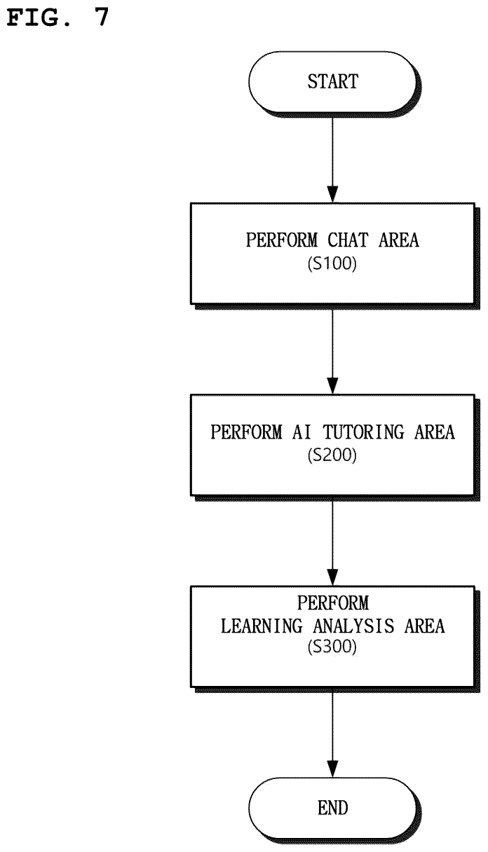

FIG. 7 is a flowchart showing a method for providing a user-tailored foreign language learning service based on an AI tutor capable of real-time interaction according to an embodiment of the present disclosure. Referring to FIG. 7, a method for providing a user-tailored foreign language learning service based on an AI tutor capable of real-time interaction may include a chat area performing step S100, an AI tutoring area performing step S200, and a learning analysis area performing step S300. Respective processes may be applied identically or similarly to the processes performed by the chat module 321, the AI tutoring module 322 and the learning analysis module 323, respectively, described above, and duplicate descriptions will be omitted.

Before the step S100, the chat module 321 collects chat messages exchanged with the user terminal 100 operated by each user through the network 200 and provides a wake-up request to the AI tutoring module 322 and the learning analysis module 323 for management, after which the chat module 321 may perform a process for the chat area (S100).

After the step S100, the AI tutoring module 322 may perform a process for the AI tutoring area that generates a conversation message based on given content and a conversation record (including a current user answer) between the chat module 321 set as an AI tutor role in the content and the user, performs a check on the answer provided by the user terminal 100 and provides an immediate feedback based on the check to fit the given content and the context of a conversation (S200).

After the step S200, the learning analysis module 323 may perform a process for the learning analysis area that analyzes the user's learning level based on the conversation record between the user and the AI tutor to recommend content suitable for the user and provide adjusted content to the user (S300).

For the sake of convenience in explanation, the steps S200 and S300 are illustrated and described as the step S200 being performed first in time, but the step S200 may be performed simultaneously with the step S300 or after the step S300.

The present disclosure may also be implemented as a computer-readable code in computer-readable recording media. The computer-readable recording media include all types of recording devices that store data that may be read by a computer system.

Examples of the computer-readable recording media include ROM, RAM, CD-ROM, magnetic tape, floppy disk, optical data storage device, and so on, and the computer-readable recording media may also be implemented in the form of a carrier wave (e.g., transmission over the Internet).

In addition, the computer-readable recording media may be distributed across computer systems connected through a network, so that a computer-readable code may be stored and executed in a distributed manner. Functional programs, codes and code segments for implementing the present disclosure may be easily inferred by programmers in the technical field to which the present disclosure pertains.

As described above, the present specification and drawings have disclosed preferred embodiments of the present disclosure, and although specific terms have been used, they are used in generic senses only to easily explain the technical contents of the present disclosure and to facilitate understanding of the present disclosure, and are not intended to limit the scope of the present disclosure. It will be apparent to those skilled in the art that, in addition to the embodiments disclosed herein, other modifications based on the technical idea of the present disclosure are possible.

A method and system for providing a user-tailored foreign language learning service based on an AI tutor capable of real-time interaction according to an embodiment of the present disclosure provides an effect of providing a user-tailored foreign language learning service based on an AI tutor capable of real-time interaction to provide an immediate feedback on a learner's answer and naturally guide learning through chat-type conversation, thereby being capable of enhancing the learner's understanding.

In addition, a method and system for providing a user-tailored foreign language learning service based on an AI tutor capable of real-time interaction according to another embodiment of the present disclosure provides an effect of providing personalized learning content to realize customized education tailored to the learning level of each user, thereby being capable of providing an efficient foreign language learning experience.

Furthermore, a method and system for providing a user-tailored foreign language learning service based on an AI tutor capable of real-time interaction according to another embodiment of the present disclosure provides an effect of outputting foreign language learning content to a learner in the form of a chat using an AI tutor chatbot, causing an AI tutor and a user to interact with each other in real time, providing a learning feedback by analyzing the learner's answer from various angles, and providing personalized learning content tailored to the learner, thereby being capable of building a system capable of determining whether the learner accurately understands and utilizes the meanings of vocabulary or expressions and providing an immediate feedback on an answer that the learner finds difficult or incorrect.

While the present invention has been described with respect to the specific embodiments, it will be apparent to those skilled in the art that various changes and modifications may be made without departing from the spirit and scope of the invention as defined in the following claims.

What is claimed is:

1. A system for providing a user-tailored foreign language learning service based on an AI tutor capable of real-time interaction, the system comprising:
a chat module configured to manage chat messages exchanged with a user who operates each user terminal; and
an AI tutoring module configured to generate a conversation message based on given content and a conversation record between the chat module set as an AI tutor role in content and the user, perform a check on an answer provided by the user terminal, and provide an immediate feedback based on the check to fit the given content and the context of a conversation.

2. The system according to claim 1, wherein the chat module:
comprises a voice recognition means configured to receive text or voice inputted from the user and convert voice into text when voice is inputted; and
manages a conversation record between the AI tutor and the user through interaction in text with the AI tutoring module.

3. The system according to claim 1, wherein the AI tutoring module comprises:
a content conversation model and a general conversation model configured to generate conversation messages by branching into cases where a user answer is within an answer matching degree and is out of the answer matching degree, according to answer matching degree analysis of the user answer in the given content and the conversation record; and
an answer discrimination model configured to determine whether a user answer is within the answer matching degree or out of the answer matching degree.

4. The system according to claim 1, wherein
the AI tutoring module comprises a feedback model configured to, when there is a grammatical error in an answer inputted by the user or when an answer is not provided in a sentence form, correct the error or provide a complete sentence as a feedback to the user terminal, and recommend a multiple-choice hint answer so that a learner is able to successfully perform a given mission.

5. The system according to claim 1, further comprising
a learning analysis module configured to analyze the user's learning level based on a conversation record between the user and the AI tutor to recommend content to the user, and provide adjusted content to the user.

6. The system according to claim 1, wherein the conversation record includes a current user answer.

7. A method for providing a user-tailored foreign language learning service based on an AI tutor capable of real-time interaction, the method comprising:
a first step in which a chat module collects chat messages exchanged with a user who operates a user terminal and provides a wake-up request to an AI tutoring module for management; and
a second step in which the AI tutoring module generates a conversation message based on given content and a conversation record between the chat module set as an AI tutor role in content and the user, performs a check on an answer provided by the user terminal and provides an immediate feedback based on the check to fit the given content and the context of a conversation.

8. The method according to claim 7, wherein the first step:
further comprises a step in which the chat module receives text or voice inputted from the user and converts voice into text when voice is inputted; and
manages a conversation record between the AI tutor and the user through interaction in text with the AI tutoring module.

9. The method according to claim 7, wherein the second step comprises:
a step in which the AI tutoring module determines whether a user answer is within an answer matching degree or out of the answer matching degree, according to answer matching degree analysis of the user answer; and
a step in which the AI tutoring module generates conversation messages by branching into cases where the user answer is within the answer matching degree and is out of the answer matching degree, according to analysis of the appropriateness of the user answer in the given content and the conversation record.

10. The method according to claim 7, wherein
the second step further comprises a step in which the AI tutoring module, when there is a grammatical error in the answer inputted by the user or when the answer is not provided in a sentence form, corrects the error or provide a complete sentence as a feedback to the user terminal, and recommends a multiple-choice hint answer so that a learner is able to successfully perform a given mission.

11. The method according to claim 7, further comprising
after the second step, a third step in which a learning analysis module analyzes the user's learning level based on a conversation record between the user and the AI tutor to recommend content to the user and provides adjusted content to the user.

12. The method according to claim 7, wherein the conversation record includes a current user answer.
